(19) United States
(12) Patent Application Publication
(10) Pub. No.: US 2020/0175010 A1
(43) Pub. Date: Jun. 4, 2020

(54) DISTRIBUTED QUERIES ON LEGACY SYSTEMS AND MICRO-SERVICES

(71) Applicant: SAP SE, Walldorf (DE)

(72) Inventors: Chintankumar Vaghani, Bengaluru (IN); Rick Banerjee, Bengaluru (IN)

(21) Appl. No.: 16/203,968

(22) Filed: Nov. 29, 2018

(51) Int. Cl. G06F 16/2458; G06F 16/2455; G06F 16/248; G06F 16/22; H04L 29/08

(52) U.S. Cl. CPC G06F 16/2471; G06F 16/2455; H04L 67/32; G06F 16/2246; G06F 16/248

(57) ABSTRACT

A distributed query engine is provided to aggregate data from and/or query a plurality of micro-services and legacy applications in multi-tenanted system in an extensible, flexible, and standards-compliant way. A plurality of dedicated connectors is provided in the distributed query engine, each providing a defined and dedicated access point to a corresponding micro-service or legacy application. A database store or database management system is associated with a corresponding one of the micro-services or the legacy applications. When a user communicates a query to the distributed query engine via a web user interface or gateway, the distributed query engine identifies one or more of the micro-services and/or legacy applications relevant to fulfilling the query, and converts the query into sub-queries, which are accordingly directed to the micro-services and/or the legacy applications to handle respective sub-queries.

### FIELD

The present disclosure generally relates to a distributed query engine and, more specifically, to utilizing a distributed query engine to aggregate data from a multitude of distinct systems.

### BACKGROUND

In a supply chain or procurement system, such as a software as a service (SaaS) system, a combination of legacy systems and micro-services may be built and provided to serve various business objectives. Data from the combination of the legacy systems and the micro-services may be consumed by a user interface (UI) or via an application program interface (API) gateway. The resulting data may, for example, be used for direct user interactions and report generation, and/or the resulting data may be pushed into a data pipeline and consumed by several downstream consumers.

### SUMMARY

Methods, systems, and articles of manufacture, including computer program products, are provided for querying a plurality of micro-services and legacy applications to aggregate data in a multi-tenanted system by utilizing a distributed query engine.

According to aspects of the current subject matter, a computer-implemented method includes: receiving, by a processing engine and from a user device in a multi-tenanted service environment, a query for execution, the processing engine having a plurality of dedicated connectors, each of the plurality of dedicated connectors connected to a respective one of a plurality of micro-services, where the query requires execution by the plurality of micro-services; converting, by the processing engine, the query into a plurality of sub-queries, where the conversion is based on data associated with the plurality of micro-services; providing, by the plurality of dedicated connectors of the processing engine, the plurality of sub-queries to corresponding ones of the plurality of micro-services; receiving, by the plurality of dedicated connectors of the processing engine and from the corresponding ones of the plurality of micro-services, a plurality of sub-results corresponding to the plurality of sub-queries; and compiling, by the processing engine, the plurality of sub-results into a resulting set to satisfy the query.

In an inter-related aspect, a system includes at least one data processor, and at least one memory storing instructions which, when executed by the at least one data processor, result in operations including: receiving, from a user device in a multi-tenanted service environment, a query for execution, where the data processor has a plurality of dedicated connectors, each of the plurality of dedicated connectors connected to a respective one of a plurality of micro-services, where the query requires execution by the plurality of micro-services; converting the query into a plurality of sub-queries, where the conversion is based on data associated with the plurality of micro-services; providing, by the plurality of dedicated connectors, the plurality of sub-queries to corresponding ones of the plurality of micro-services; receiving, by the plurality of dedicated connectors and from the corresponding ones of the plurality of micro-services, a plurality of sub-results corresponding to the plurality of sub-queries; and compiling the plurality of sub-results into a resulting set to satisfy the query.

In an inter-related aspect, a non-transitory computer-readable storage medium includes program code, which when executed by at least one data processor, causes operations including: receiving, from a user device in a multi-tenanted service environment, a query for execution, where the at least one data processor has a plurality of dedicated connectors, each of the plurality of dedicated connectors connected to a respective one of a plurality of micro-services, where the query requires execution by the plurality of micro-services; converting the query into a plurality of sub-queries, where the conversion is based on data associated with the plurality of micro-services; providing, by the plurality of dedicated connectors, the plurality of sub-queries to corresponding ones of the plurality of micro-services; receiving, by the plurality of dedicated connectors and from the corresponding ones of the plurality of micro-services, a plurality of sub-results corresponding to the plurality of sub-queries; and compiling the plurality of sub-results into a resulting set to satisfy the query.

In some variations, one or more of the features disclosed herein including the following features can optionally be included in any feasible combination. The conversion into the plurality of sub-queries may be further based on prefixes included in the query. The data associated with the plurality of micro-services may be associated with the corresponding plurality of dedicated connectors, where the plurality of dedicated connectors are registered with the processing engine. Providing the plurality of sub-queries may include generating, by the plurality of dedicated connectors, an application program interface call based on a mapping of the plurality of sub-queries and the data associated with the plurality of micro-services. The mapping may be based on metadata extracted from the plurality of micro-services. The plurality of micro-services may obtain the plurality of sub-results through respective ones of a data access layer connection with a database store. Compiling the plurality of sub-results into the resulting set may include flattening each of the plurality of sub-results from a hierarchical representation into one or more records of rows with column values comprising required fields of data from the plurality of micro-services. Flattening may include generating a tree comprising a root node and one or more child nodes, where the root node and the one or more child nodes include the required fields of data.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram illustrating an environment consistent with implementations of the current subject matter;

FIG. 2 is a block diagram depicting aspects of generating a request for data for a micro-service consistent with implementations of the current subject matter;

FIG. 3 is a block diagram depicting aspects of a micro-service retrieving data consistent with implementations of the current subject matter;

FIG. 4 is a block diagram depicting aspects of a legacy application retrieving data consistent with implementations of the current subject matter;

FIG. 5 is a block diagram depicting aspects of a legacy application retrieving data consistent with additional implementations of the current subject matter;

FIG. 6 is a tree diagram illustrating flattening concepts for retrieved representations consistent with implementations of the current subject matter;

FIG. 7 is a block diagram depicting aspects of running queries across disparate data centers consistent with implementations of the current subject matter;

FIG. 8 depicts a flowchart illustrating a process for querying a plurality of micro-services and legacy applications consistent with implementations of the current subject matter; and

FIG. 9 depicts a block diagram illustrating a computing system consistent with implementations of the current subject matter.

Like labels are used to refer to same or similar items in the drawings.

### DETAILED DESCRIPTION

Micro-services may typically have flexible architectures in which various programming languages, frameworks, and storage structures may be utilized to fulfill one or more business functions. In a multi-tenanted SaaS system or a supply chain process domain, for example, one or more micro-services may combine with one or more legacy systems or applications. Various micro-services may be added to augment existing services or provide new services, and each micro-service may have its own programming language and/or backend technology. Similarly, various legacy systems or applications may be added for additional services. Each of these micro-services and legacy applications may be independent from one another with different business functionalities, resulting in data being spread apart across the micro-services and legacy applications.

In some instances, complex cases may emerge, requiring aggregation of data from various micro-services and legacy applications. In order to deliver the required data from the various micro-services and legacy applications, an architecture and data flow may evolve in which some sort of aggregator service or orchestration service are utilized. Such services retrieve data from the various micro-services and legacy applications to provide requested data and/or to answer questions relevant to the multi-tenanted system. However, this approach in aggregating data across various sources is problematic for a number of reasons. In particular, access of the aggregated data is limited by the functionality provided by the API exposed by the aggregation service, which may be inflexible for the user and/or customer.

As an example, if in a procurement application a user desires to know the details of all requisitions for a particular user, an API similar to the following would need to be exposed: List<Requisition>getRequisitionsByUser (String::userId). This is a very specific API, written to answer a specific question. It is difficult to reuse it to answer other questions. If business users require more ways to look at or obtain the data, they have no choice but to request new APIs. This time consuming and not always feasible.

Another problematic issue with the approach of using an aggregator service or orchestration service in which customized APIs are required is that the output from the aggregation may need to be fine-tuned or tailored for the user. To continue with the previous example, the expected output may require a listing of details about the requisitions and those details may include, for example, requisition identifier, requisition description, and requisition approver. However, at some point after the specific API is written, the user may wish to incorporate additional fields or details, such as a commodity code related to the requisitions. Such a change necessitates a change in the API, and a new version of the API would need to be written.

Thus the approach of delivering required data from the various micro-services and legacy applications in which customized APIs are required may lead to an unmanageable amount of APIs that need to be exposed, monitored, and metered.

In implementations of the current subject matter, a distributed query engine is configured to aggregate data from and/or query a plurality of micro-services and legacy applications in an extensible, flexible, and standards-compliant way. In some implementations of the current subject matter, the plurality of micro-services and legacy applications are treated as a plurality of data sources.

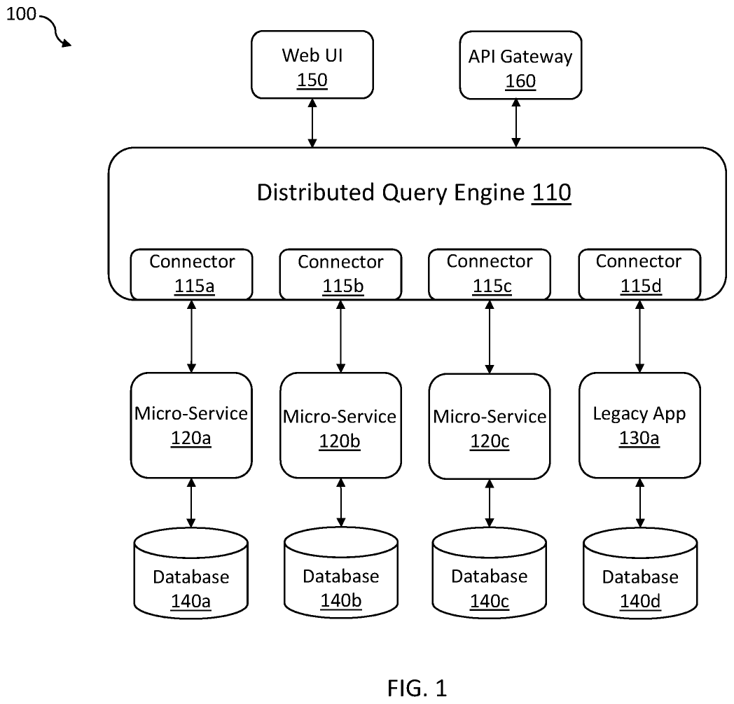

FIG. 1 depicts a block diagram illustrating an environment 100 consistent with implementations of the current subject matter. Referring to FIG. 1, a distributed query engine 110 may include a number of connectors 115 (e.g., connectors 115a through 115d, although fewer or additional connectors may be included). Each of the connectors 115 provides a defined and dedicated access point to a corresponding micro-service 120 or legacy application 130 (the connector 115a couples to the micro-service 120a, the connector 115b couples to the micro-service 120b, the connector 115c couples to the micro-service 120c, and the connector 115d couples to the legacy application 130a). A database or database management system 140 may be associated with a corresponding one of the micro-services 120 or the legacy applications 130. The connection between the connectors 115 and the micro-services 120 and the legacy applications 130 may be via a wired and/or wireless network, such as a wide area network (WAN), a local area network (LAN), and/or the Internet.

In some implementations of the current subject matter, a user may communicate with the distributed query engine 110 via a wired and/or wireless network connection from a web user interface (UI) 150 and/or an API gateway 160. In particular, the user submits a query (e.g., a SQL statement or the like) to the distributed query engine 110 through the web UI 150 and/or the API gateway 160. Executing the query received from the web UI 150 or the API gateway 160 may require data from multiple ones of the micro-services 120 and/or the legacy applications 130. As such, fulfilling the query may require the use of data stored at and/or managed by one or more of the micro-services 120 and/or the legacy applications 130. Thus, according to implementations of the current subject matter, the distributed query engine 110 is configured to identify one or more micro-services 120 and/or legacy applications 130 relevant to fulfilling the query, the details of which are further described herein.

Consistent with implementations of the current subject matter, the specific framework of the distributed query engine 110 may be any suitable framework that is capable of executing distributed SQL queries over data from various data sources (the micro-services 120 and/or the legacy applications 130). The use of SQL queries provides a standards-based way to aggregate and extract data. The distributed query engine 110 is configured to convert the received SQL query into sub-queries and then execute each of the sub-queries on specific micro-services 120 and/or legacy applications 130. In accordance with implementations of the current subject matter, data and/or metadata from the micro-services 120 and/or the legacy applications 130 is fetched using a representational state transfer (REST) API. REST APIs provide for interoperability between the distributed query engine 110 and the micro-services 120 and/or the legacy applications 130, thus allowing the micro-services 120 and the legacy applications 130 to not be limited to a particular programming language, framework, and storage structure, and further to not require modifications for the data extraction and aggregation. In some implementations, other types of interfaces, including any type of API, may be used for interoperability between the distributed query engine 110 and the micro-services 120 and/or the legacy applications 130. For example, a simple object access protocol (SOAP) based web service call or a proprietary remote procedure call (RPC) may be used. Consistent with implementations of the current subject matter, the REST APIs (or other interfaces) are a specific set of basic APIs that are programmed without knowledge of the connectors 115. The APIs are implemented by the micro-services 120 and/or the legacy applications 130 that are acting as data sources. The connectors 115 use these basic APIs to fetch data, using for example a primary key and/or basic filter conditions.

Revisiting the example of a user desiring to know the details of all requisitions for a particular user, rather than the specific API written specifically to answer such a particular request, the following SQL query may be written:
Select Requisition.RequisitionId, Requisition.Description,
Requisition.Approver;
From procurement.Requisition, masterdata.User;
Where Requisition.UserId=User.UserId and User.UserName=‘john.doe’.

Here, the “procurement” prefix before “Requisition” indicates to the distributed query engine 110 that the details of the requisition need to be fetched using a particular connector 115 that connects to a corresponding procurement micro-service 120 or legacy application 130. Similarly, the “masterdata” prefix before “User” indicates to the distributed query engine 110 that the master data need to be fetched using the connector 115 that will fetch the master data from the user data source, which may be either one of the micro-services 120 or the legacy applications 130.

This example demonstrates the immense flexibility in being able to query a collection of the micro-services 120 and the legacy applications 130 in a uniform, standards-compliant way, through using a rich syntax.

Continuing with the example discussed earlier, if more information is required in the response of the aggregation or query, it is trivial to alter the query to the following:
Select Requisition.RequisitionId, Requisition.Description,
Requisition.Approver, Requisition.CommodityCode;
From procurement.Requisition, masterdata.User;
Where Requisition.UserId=User.UserId and User.UserName=‘john.doe’.

No new API is needed, and such fine-grained control is easily available to the business end users at the web UI 150 and the API gateway 160.

Consistent with implementations of the current subject matter, the connectors 115 in the distributed query engine 110 receive SQL sub-queries and are configured to respond with the data from their underlying data source (the micro-service 120 or the legacy application 130). Each of the connectors 115 are registered with the distributed query engine 110. The registration includes connector configuration data with details of the underlying micro-service 120 or legacy application 130 to allow for the data and metadata to be properly fetched.

According to implementations of the current subject matter, runtime environment specific configuration files may exist for each connector 115. For example, a develop environment, meant to deploy the solution for testing of individual components/connectors 115, may be provided. An integration environment for testing of multiple connectors 115 together may be provided. A production environment, for deploying the solution for use by customers/consumers of the service, may be provided.

Table 1 includes examples of connector configuration data for various environments.

TABLE 1
Filename: masterdata-config-dev.json
{

```
“apiType”: “masterdata”,
“prefix”: “masterdata”,
“baseUrls”: [
  http://svcdev.ariba.com
],
“apiAttributes”: {
  “ISSSPPULL”: true
},
“authServerInfo”: {
  “authServerUrl”: “http://dev-oauth-server:13130/private/v2/oauth/token”,
  “authAttributes” : {
  “clientId”: “masterdata-2lo-client”,
  “clientSecret.VaultKey”: “private-masterdata-2lo1”
  }
}
```

}
Filename: masterdata-config-itg.json
{

```
“apiType”: “masterdata”,
“prefix”: “masterdata”,
“baseUrls”: [
  http://svcitg.ariba.com
],
“apiAttributes”: {
  “ISSSPPULL”: true
},
“authServerInfo”: {
  “authServerUrl”: “http://itg-oauth-server:13130/private/v2/oauth/token”,
  “authAttributes” : {
  “clientId”: “masterdata-2lo-client”,
  “clientSecret.VaultKey”: “private-masterdata-2lo1”
  }
}
```

}
Filename: masterdata-config-prod.json
{

```
“apiType”: “masterdata”,
“prefix”: “masterdata”,
“baseUrls”: [
  https://svcprod.ariba.com
],
“apiAttributes”: {
  “ISSSPPULL”: true
},
“authServerInfo”: {
  “authServerUrl”: “https://prod-oauth-server/private/v2/oauth/token”,
  “authAttributes” : {
  “clientId”: “masterdata-2lo-client”,
  “clientSecret.VaultKey”: “private-masterdata-2lo1”
  }
}
```

}

These configurations may either be static and deployed with the code, or dynamic and uploaded to the distributed query engine 110 using an API.

Consistent with implementations of the current subject matter, the files shown above may be read by the distributed query engine 110, on bootstrap, and parsed to create in-memory representations. These may then be used to route the correct sub-query to the correct connector 115. The connector 115 uses this configuration to make the correct API requests to the concerned micro-service 120 or legacy application 130. This process is fairly static and pre-decided. In other implementations, a more dynamic approach may be utilized in which the connectors 115 are added during runtime, using APIs. The distributed query engine 110 may respond to the API request by refreshing its in-memory data structures, and begin to recognize and assign requests to the newly added connector 115.

Consistent with implementations of the current subject matter, to generate the REST API call and retrieve data, the connector 115 needs to know the mapping between the entities and columns in the query and the entities and their fields in the data model of the micro-service 120 or the legacy application 130. To accomplish this, the connector 115 uses the metadata, which is extracted from the micro-service 120 or the legacy application 130 and is made available to the connector 115. In the example discussed earlier, the metadata may be as in Table 2.

TABLE 2

```
{
  “tables”: [
  {
```

“tableType”: “procurement”,
“name”: “Requisition”,
“mappedEntityName”: “purchasing.core.Requisition”,
“columns”: [
{

“name”: “ RequisitionId”,
“mappedColumn”: “RequisitionIdentifier”,
“type”: “NUMBER”

```
  },
  {
```

“name”: “ Description”,
“mappedColumn”: “RequisitionDesc”,
“type”: “VARCHAR”

```
  },
  {
```

“name”: “ Approver”,
“mappedColumn”: “RequisitionApprover”,
“type”: “VARCHAR”

```
  },
  {
```

“name”: “ CommodityCode”,
“mappedColumn”: “ReqProductCode”,
“type”: “VARCHAR”

}
]

```
  },
  {
```

“tableType”: “masterdata”,
“name”: “user”:
“mappedEntityName”: “common.core.User”,
“columns”: [
{

“name”: “UserId”,
“mappedColumn”: “uId”,
“type”: “NUMBER”

```
  },
  {
```

“name”: “ UserName”,
“mappedColumn”: “uName”,
“type”: “VARCHAR”

}
]

```
  }
  ]
}
```

A REST call generated by the connector 115 may be as follows:

```
GET \
‘https://procurement-
service/requisitions?realm=company1&globalId=AAAAAPIFQ
Z’ \
  -H ‘Authorization: Bearer 0060e757-d9d5-4cf3-8a44-
3356aec209e4’ \
  -H ‘Cache-Control: no-cache’ \
```

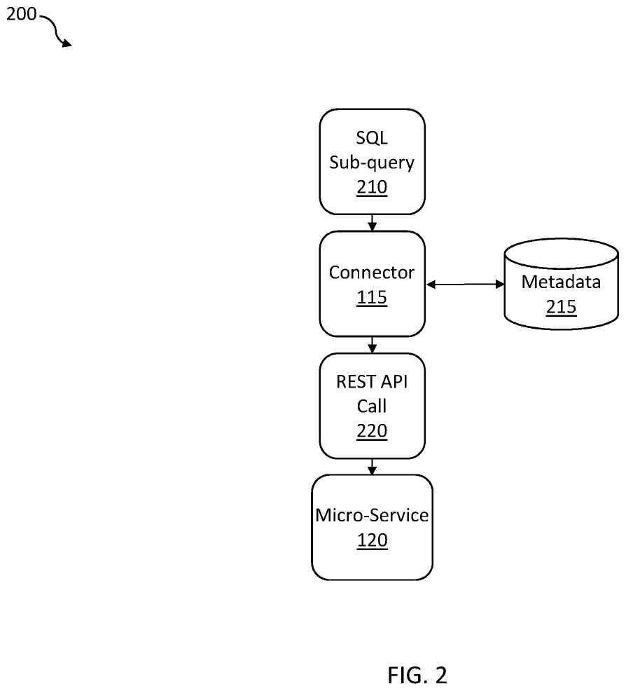

FIG. 2 illustrates a block diagram 200 depicting aspects for generating a request for data (e.g., a REST API call) to retrieve data to answer a SQL query consistent with implementations of the current subject matter. A SQL sub-query 210, which is part of the SQL query converted by the distributed query engine 110, is sent to the connecter 115 for the particular micro-service 120 that has the data necessary for executing the sub-query 210. The connector 115 accesses the metadata 215 for the particular micro-service 120. The connector 115 generates the REST API call 220, which is sent by the connector 115 to the micro-service 120.

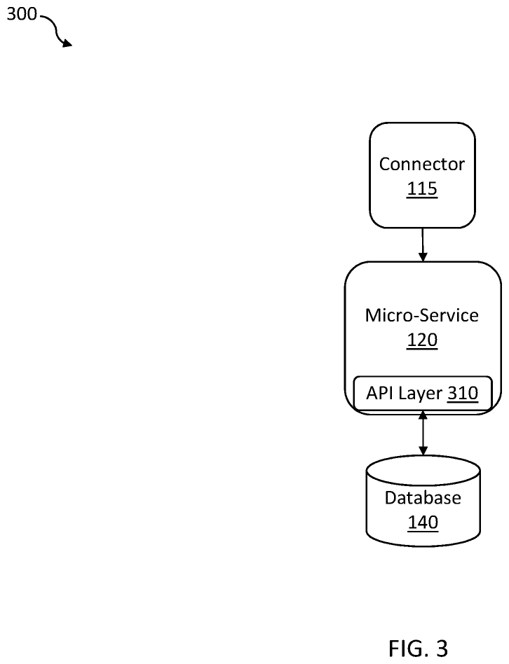

Rather than the connector 115 duplicating functionality present in the data access layer of the micro-service 120 by directly retrieving data from the most common data sources (such as databases, document stores (e.g., MongoDB) and file systems (e.g., distributed file systems such as HDFS)), a standard REST interface is, consistent with implementations of the current subject matter, implemented at the micro-service API layer such that the connecter 115 retrieves data through this API rather than directly accessing the data sources. This is illustrated in the block diagram 300 of FIG. 3, which shows the connector 115 accessing data from the micro-service 120 consistent with implementations of the current subject matter. As shown in FIG. 3, the micro-service API layer 310, which is part of the data access layer code that is already part of the micro-service 120, retrieves the data from the database 140.

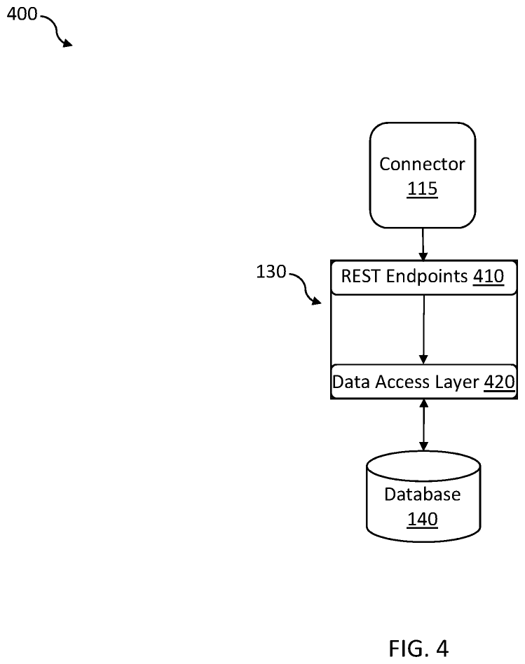

When extracting data from legacy applications 130, there are at least two options that may be considered, consistent with implementations of the current subject matter. One option is shown with respect to the block diagram 400 of FIG. 4. Implementing REST endpoints 410 within the legacy application 130 that support data retrieval by a global primary key allow for retrieval of data by the legacy application 130. The REST endpoints 410 use the data access layer 420 to retrieve data from the legacy application's data store of choice (e.g., the database 140). The legacy connector 115 in the distributed query engine 110 uses the REST endpoints 410 to query for data.

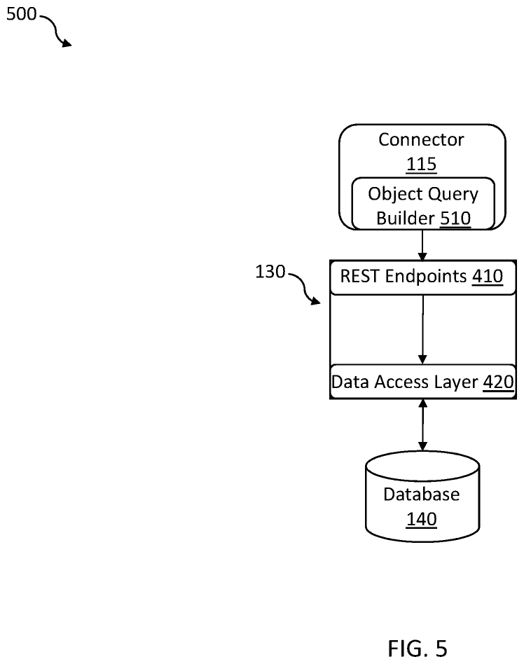

Another option for extracting data from the legacy application 130 is illustrated with respect to the block diagram 500 of FIG. 5. For example, in more complex scenarios, where the domain specific queries are too complex to be represented using simple REST APIs, a query conversion may be required. The sub-query, converted from the input SQL query, is converted by object query builder 510 into a proprietary object query language which is sent to the servlet or REST endpoint 410. The endpoint 410 runs the query by utilizing the data access layer 420 to retrieve data from the legacy application's data store (e.g., the database 140).

According to additional aspects of the current subject matter, the data retrieved from the micro-services 120 and the legacy applications 130 may be in the form of hierarchical data (such as JavaScript Object Notation (JSON) representations of domain objects). This is a non-trivial problem since commercial off-the-shelf libraries that offer flattening functionality do not understand the semantics of the domain objects that are being flattened and often create Cartesian products rather than properly formed flattened records. Consistent with implementations of the current subject matter, the retrieved hierarchical data is flattened into record rows by the distributed query engine 110 to produce the output or result of the query.

In particular, the micro-services 120 may expose REST APIs (the micro-service API layer 310) and handle request responses in JSON format, which may be a simple or nested format. Consistent with implementations of the current subject matter, the JSON representations are flattened and the required field to give column values for each of the rows is selected.

As an example, consider the connecter 115 responsible for fetching data related to department table from the micro-service 120 which serves as the data source. An example response coming from the micro-service API layer 310 may be as in Table 3.

TABLE 3

```
{
  ″department_name″: ″engineering″:
  ″department_id″: ″dep_101″:
  ″address″: {
  ″address_id″: ″Add_123″:
  ″city″: ″Bangalore″:
  “pincode”: “567788”
  },
  ″employees″: [
  {
```

″firstName″: ″John″:
″lastName″: ″Doe″:
″age″: 23

```
  },
  {
```

″firstName″: ″Mary″:
″lastName″: ″Smith″:
″age″: 32

```
  }
  ]
}
```

If the query requires department name, city from the department address, and firstName and lastName of department employees, the connector 115 needs to return the following record set of rows to the distributed query engine 110:
Engineering, Bangalore, John, Doe
Engineering, Bangalore, Mary, Smith

Thus from this example it is seen that the JSON representation needs to be flattened to replicate the top-level column values for each of the nested array. In some instances, there may be a JSON array with m and n count at the same level, and if fields are selected from both arrays, the row count gets multiplied (m*n). Additionally, the JSON needs to be flattened to the level at which fields are required to be selected. The entire JSON should not be flattened, which unnecessarily creates duplicate rows.

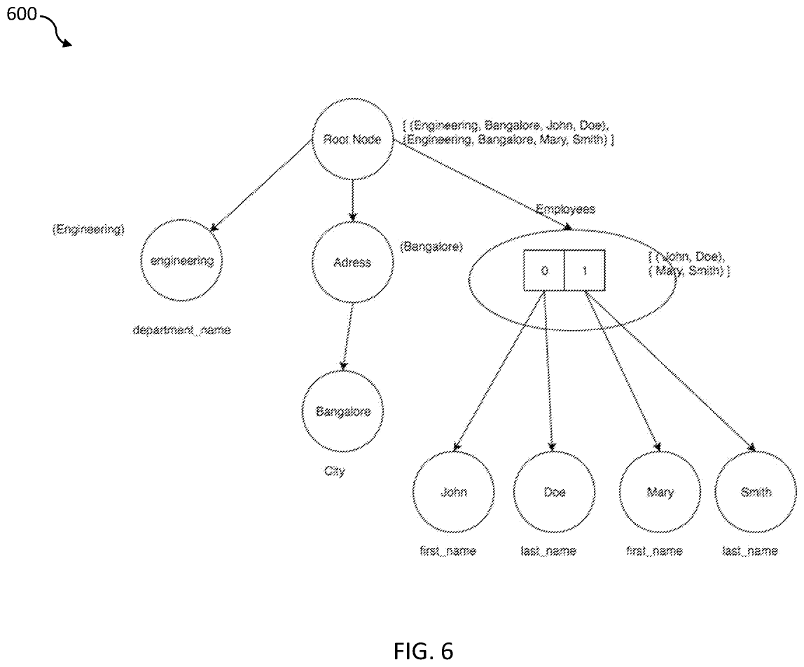

FIG. 6 is an exemplary tree diagram 600 that illustrates the flattening concepts for JSON representations consistent with implementations of the current subject matter. A bottom-up approach is utilized for the tree to create records at the nodes of each level, which are combined based on whether the nodes are objects or arrays.

Consistent with implementations of the current subject matter, two steps involved in the tree diagram solution are to first create a tree for required fields reflecting the JSON structure, and to then create records from the created tree by utilizing a bottom-up approach. A recursive algorithm to create the tree (depth first traversal) may be as follows:
1. Create a root node for the tree for a JSON root (entire JSON object of the JSON as the value of root node and mark it as current node);
2. Obtain the immediate child field values which are required to be selected under JSON object value of the current node;
3. Child fields may have three types of values under JSON: Primitive, JsonObject, and JsonArray:
   a. If the value is primitive, then add it as child leaf node of current node and set primitive value as the tree node value;
   b. If the value is JSON object, create a non-leaf node, add it as child node of the current node, and set the JSON object as the value of that node. Now mark this node as current node and repeat steps one and two for that node;
   c. If the value is JSON array:
      i. Create tree nodes for each element in JSON array, set the value of that element as node value, and add those tree nodes to separate array;
      ii. Create a non-leaf node, which will have value as the array created in previous step above, and add it as child of current node; and
      iii. Traverse each of the tree nodes in array, mark them as current node, and repeat steps one and two for them one by one.

The records are created by traversing the created tree in a bottom-up approach. The algorithm, consistent with implementations of the current subject matter, to create a record at each node is described below. The records at the root node are the result as depicted in FIG. 6. In the algorithm below, the record is noted as a set of column values (column values may be from one or more).
1. Start from the root node, and mark it as current node;
2. Current node can be one of three types:
   a. leaf node;
   b. non-leaf node with JSON object as value; or
   c. Non-leaf node with array of tree nodes as value;
3. If current node is leaf node, the value of the node is the record for that node. Record count of the leaf node here is one;
4. If current node is JSON object:
   a. Go to each child node of the current node, mark them as current node, and repeat from step two;
   b. At the end of the above, each of the child nodes have records attached to it;
   c. Multiply records of each child nodes, and the resultant record is the record of that node. Here, final record count is the multiplication of the record count of each node. Here, each record at child node is cross joined with sibling child node;
5. If the current node is array of tree nodes:
   a. Go to each of the tree nodes of array one by one, mark them as current node, and repeat from step two;
   b. At the end of the above, each of the array nodes have records attached to it;
   c. Add record of each node of array, and the final result is the records of that node.

For step four of the algorithm, if the current node is a JSON object, an example if there are three child nodes called may be as follows:
A (recordcount=1, records=recordA),
B (recordcount=2, records=[(recordB1), (recordB2)]) and
C (recordcount=3, records=[(recordC1), (recordC2), (recordC3]),

The final record count will be six, and the final records will be:
[(recordA, recordB1, recordC1),
(recordA, recordB1, recordC2),
(recordA, recordB1, recordC3),
(recordA, recordB2, recordC1),
(recordA, recordB2, recordC2),
(recordA, recordB2, recordC3)]

For step five of the algorithm, if the current node is an array of tree nodes, an example if the node has two elements in the array may be as follows:
[recordA11, recordA12] and
[recordA21, recordsA22, recordsA23], respectively.

Final records in this case will be:
[(recordA11), (recordA12), (recordA21),(recordsA22), (recordsA23)]

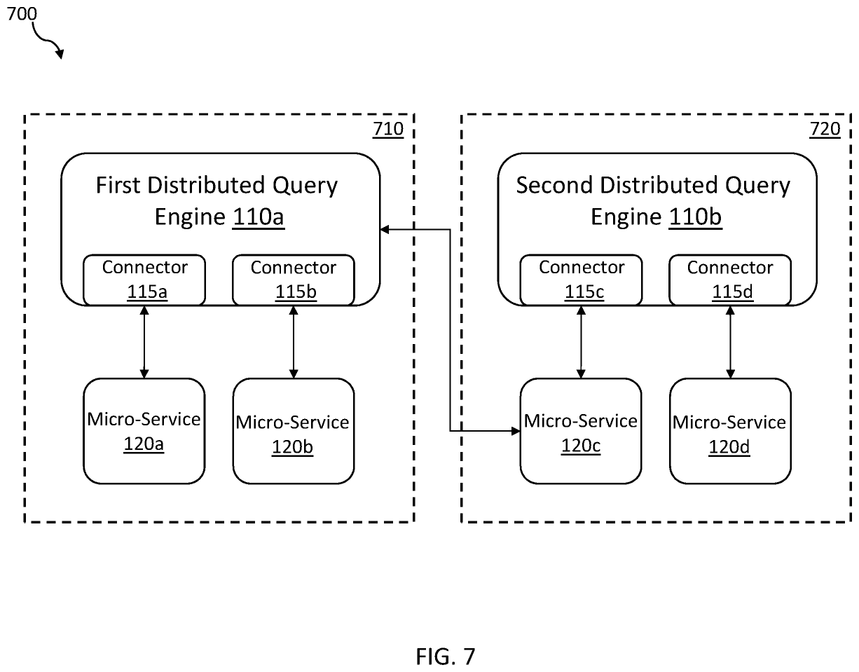

Consistent with implementations of the current subject matter, queries across disparate data centers may also be realized. FIG. 7 is a block diagram 700 illustrating aspects related to running queries across data centers. In particular, a first data center 710 is provided that includes a first distributed query engine 110a with connectors 115a and 115b connected to micro-services 120a and 120b, respectively. A second data center 720 includes a second distributed query engine 110b with connectors 115c and 115d connected to micro-services 120c and 120d, respectively. A query received by the first distributed query engine 110a may require data from one or more of the micro-services 120c,d in the second data center 720. Similarly, a query received by the second distributed query engine 110b may require data from one or more of the micro-services 120a,b in the first data center 710. Consistent with implementations of the current subject matter, a cross-data center query may be as follows:
Select UserName, UserId
From dc1.masterdata.User
Where IsContractor=true
UNION
Select UserName, UserId
From dc2.masterdata.User
Where IsContractor=true

This query easily finds contractors from two geographical regions (where the geographical regions are represented by the disparate data centers 710 and 720). The prefixes “dc1” and “dc2” are used by the distributed query engine 110a to route the request to the appropriate micro-service 120 in the correct data center.

In the scenario illustrated in FIG. 7, a connector 115 is utilized to send the sub-query to the micro-service 120 or the legacy application 130 in a different data center. According to aspects of the current subject matter, based on the query prefix, the distributed query engine 110 is directed to fetch data from a micro-service 120 or a legacy application 130 in a different data center. The distributed query engine 110 fetches this data using a connector 115. Configuration for the connector 115 may contain details such as which URL to use and authentication mechanisms.

More complex queries, for example to join tables on appropriate common attributes such as commodity codes, may also be written. This same behavior can also be achieved without the join, for example by using the connector to help resolve the URIs of the services that are deployed in the two data centers. In this instance, the connector sends two separate requests, the results of which may be joined in-memory with the resulting set returned to the client that submitted the query.

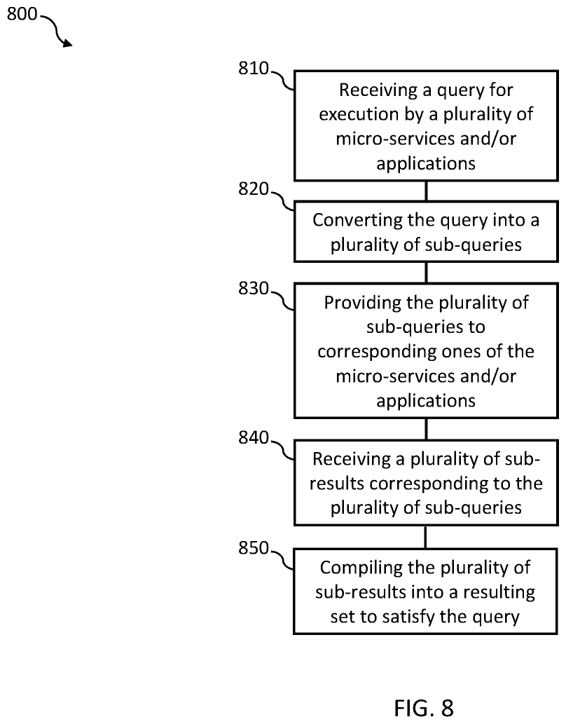

FIG. 8 depicts a flowchart 800 illustrating a process for querying the combinations of micro-services 120 and legacy applications 130 consistent with implementations of the current subject matter.

At 810, the distributed query engine 110 receives a query for execution. For example, a user may submit a query from the web UI 150 and/or the API gateway 160, where the query requires data from multiple ones of the micro-services 120 and/or the legacy applications 130. As described elsewhere herein, the distributed query engine 110 includes a number of dedicated connectors 115, each associated with a respective one of the micro-services 120 or the legacy applications 130.

At 820, the distributed query engine 110 converts the received query into a plurality of sub-queries. The sub-queries are based on, for example, respective ones of the micro-services 120 and the legacy applications 130 that are associated with the data necessary to execute or answer a respective sub-query. That is, the query is split into sub-queries to accordingly direct each sub-query to the micro-service 120 or the legacy application 130 that can execute the particular sub-query. At 830, the connectors 115 provide the sub-queries to corresponding ones of the micro-services 120 and/or the legacy applications 130. The connectors 115 are provided with appropriate sub-queries from the distributed query engine 110 based on this analysis.

At 840, the connectors 115 receive answers from the corresponding one of the micro-services 120 and/or the legacy application 130. The answers are sub-results that result from executing the sub-query for a particular one of the micro-services 120 and/or legacy the applications 130.

At 850, the distributed query engine 110 compiles the plurality of sub-results into a resulting set to satisfy the query. The resulting set is provided to the user through the web UI 150 and/or the API gateway 160. Compiling the results may include flattening any hierarchical results that are received, which may include providing one or more sets or records of rows with column values that include the required fields of data from the micro-service 120 and/or the application 130. The flattening process may include generating a tree comprising a root node and one or more child nodes, where the nodes include the required fields of data.

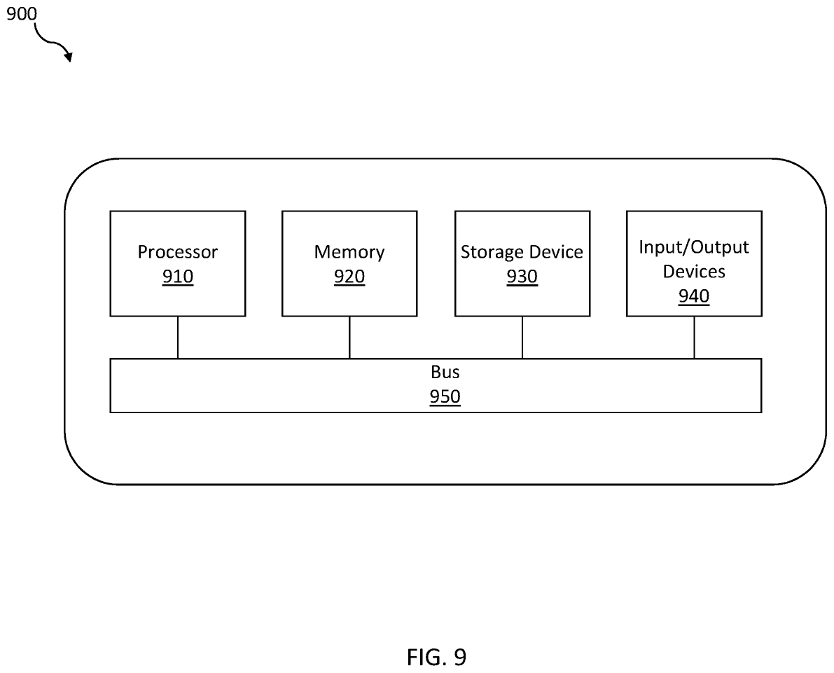

FIG. 9 depicts a block diagram illustrating a computing system 900 consistent with implementations of the current subject matter. Referring to FIGS. 1 and 9, the computing system 900 can be used to implement the distributed query engine 110 and/or any components therein.

As shown in FIG. 9, the computing system 900 can include a processor 910, a memory 920, a storage device 930, and input/output devices 940. The processor 910, the memory 920, the storage device 930, and the input/output devices 940 can be interconnected via a system bus 950. The processor 910 is capable of processing instructions for execution within the computing system 900. Such executed instructions can implement one or more components of, for example, the distributed query engine 110. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940.

The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A computer-implemented method, comprising:
receiving, by a processing engine and from a user device in a multi-tenanted service environment, a query for execution, the processing engine comprising a plurality of dedicated connectors, each of the plurality of dedicated connectors connected to a respective one of a plurality of micro-services, wherein the query requires execution by the plurality of micro-services;
converting, by the processing engine, the query into a plurality of sub-queries, wherein the conversion is based on data associated with the plurality of micro-services;
providing, by the plurality of dedicated connectors of the processing engine, the plurality of sub-queries to corresponding ones of the plurality of micro-services;
receiving, by the plurality of dedicated connectors of the processing engine and from the corresponding ones of the plurality of micro-services, a plurality of sub-results corresponding to the plurality of sub-queries; and
compiling, by the processing engine, the plurality of sub-results into a resulting set to satisfy the query.

2. The computer-implemented method of claim 1, wherein the conversion into the plurality of sub-queries is further based on prefixes included in the query.

3. The computer-implemented method of claim 1, wherein the data associated with the plurality of micro-services is associated with the corresponding plurality of dedicated connectors, wherein the plurality of dedicated connectors are registered with the processing engine.

4. The computer-implemented method of claim 1, wherein providing the plurality of sub-queries comprises:
generating, by the plurality of dedicated connectors, an application program interface call based on a mapping of the plurality of sub-queries and the data associated with the plurality of micro-services.

5. The computer-implemented method of claim 4, wherein the mapping is based on metadata extracted from the plurality of micro-services.

6. The computer-implemented method of claim 1, wherein the plurality of micro-services obtain the plurality of sub-results through respective ones of a data access layer connection with a database store.

7. The computer-implemented method of claim 1, wherein compiling the plurality of sub-results into the resulting set comprises:
flattening each of the plurality of sub-results from a hierarchical representation into one or more records of rows with column values comprising required fields of data from the plurality of micro-services.

8. The computer-implemented method of claim 7, wherein flattening comprises:
generating a tree comprising a root node and one or more child nodes, wherein the root node and the one or more child nodes include the required fields of data.

9. A system, comprising:
at least one data processor; and
at least one memory storing instructions which, when executed by the at least one data processor, result in operations comprising:
receiving, from a user device in a multi-tenanted service environment, a query for execution, wherein the data processor comprises a plurality of dedicated connectors, each of the plurality of dedicated connectors connected to a respective one of a plurality of micro-services, wherein the query requires execution by the plurality of micro-services;
converting the query into a plurality of sub-queries, wherein the conversion is based on data associated with the plurality of micro-services;
providing, by the plurality of dedicated connectors, the plurality of sub-queries to corresponding ones of the plurality of micro-services;
receiving, by the plurality of dedicated connectors and from the corresponding ones of the plurality of micro-services, a plurality of sub-results corresponding to the plurality of sub-queries; and
compiling the plurality of sub-results into a resulting set to satisfy the query.

10. The system of claim 9, wherein the conversion into the plurality of sub-queries is further based on prefixes included in the query.

11. The system of claim 9, wherein the data associated with the plurality of micro-services is associated with the corresponding plurality of dedicated connectors, wherein the plurality of dedicated connectors are registered with the data processor.

12. The system of claim 9, wherein providing the plurality of sub-queries comprises:
generating, by the plurality of dedicated connectors, an application program interface call based on a mapping of the plurality of sub-queries and the data associated with the plurality of micro-services.

13. The system of claim 12, wherein the mapping is based on metadata extracted from the plurality of micro-services.

14. The system of claim 9, wherein the plurality of micro-services obtain the plurality of sub-results through respective ones of a data access layer connection with a database store.

15. The system of claim 9, wherein compiling the plurality of sub-results into the resulting set comprises:
flattening each of the plurality of sub-results from a hierarchical representation into one or more records of rows with column values comprising required fields of data from the plurality of micro-services.

16. The system of claim 15, wherein flattening comprises:
generating a tree comprising a root node and one or more child nodes, wherein the root node and the one or more child nodes include the required fields of data.

17. A non-transitory computer-readable storage medium including program code, which when executed by at least one data processor, causes operations comprising:
receiving, from a user device in a multi-tenanted service environment, a query for execution, wherein the at least one data processor comprises a plurality of dedicated connectors, each of the plurality of dedicated connectors connected to a respective one of a plurality of micro-services, wherein the query requires execution by the plurality of micro-services;
converting the query into a plurality of sub-queries, wherein the conversion is based on data associated with the plurality of micro-services;
providing, by the plurality of dedicated connectors, the plurality of sub-queries to corresponding ones of the plurality of micro-services;
receiving, by the plurality of dedicated connectors and from the corresponding ones of the plurality of micro-services, a plurality of sub-results corresponding to the plurality of sub-queries; and
compiling the plurality of sub-results into a resulting set to satisfy the query.

18. The non-transitory computer-readable storage medium of claim 17, wherein providing the plurality of sub-queries comprises:
generating, by the plurality of dedicated connectors, an application program interface call based on a mapping of the plurality of sub-queries and the data associated with the plurality of micro-services.

19. The non-transitory computer-readable storage medium of claim 17, wherein the plurality of micro-services obtain the plurality of sub-results through respective ones of a data access layer connection with a database store.

20. The non-transitory computer-readable storage medium of claim 17, wherein compiling the plurality of sub-results into the resulting set comprises:
flattening each of the plurality of sub-results from a hierarchical representation into one or more records of rows with column values comprising required fields of data from the plurality of micro-services.
